(19) United States
(12) Patent Application Publication
(10) Pub. No.: US 2026/0263980 A1
(43) Pub. Date: Sep. 10, 2026

(54) FILTERING DEVICE AND MOUNTING STRUCTURE

(71) Applicant: YAMASHIN-FILTER CORP., Kanagawa (JP)

(72) Inventors: Tatsuya OYAMA, Kanagawa (JP); Youichi NODOMI, Kanagawa (JP)

(21) Appl. No.: 19/553,003

(22) Filed: Feb. 27, 2026

(30) Foreign Application Priority Data
Mar. 4, 2025 (JP) 2025-034038

(51) Int. Cl. B01D 46/00; B01D 29/13; B01D 35/157; B01D 46/24; B01D 46/42

(52) U.S. Cl. CPC B01D 46/0005; B01D 29/13; B01D 35/1573; B01D 46/2403; B01D 46/4272; B01D 2201/16; B01D 2201/34; B01D 2201/4046; B01D 2265/06; B01D 2271/02

(57) ABSTRACT

A filtering device includes a fixing member, a filter element including a cylindrical filtering member and a plate provided at one end of the filtering member, a valve provided at the fixing member or the filter element, and a sealing member having an annular shape and provided at the fixing member or the filter element. A first tubular portion including a protruding portion is provided at one of the fixing member and the plate, and a second tubular portion including a recessed portion into which the protruding portion is inserted is provided at the other of the fixing member and the plate. The recessed portion extends along a central axis of the second tubular portion has a shape in which a first recessed portion with one end opening at an opening edge of the second tubular portion, and a second recessed portion extending circumferentially are coupled with each other.

### TECHNICAL FIELD

The present invention relates to a filtering device and a mounting structure.

### BACKGROUND ART

Patent Document 1 discloses a filter device in which a connection tube of a head is inserted inside a tubular portion formed at an upper plate of a filter element, and the tubular portion and the connection tube are fixed and sealed using an elastic member provided between the tubular portion and the connection tube.

### Citation List

### Patent Literature

Patent Document 1: JP 2023-109619 A

In the filter device disclosed in Patent Document 1, the filter element is provided inside a case threadedly engaged with the head, and the filter element is replaced by pulling out the filter element downward after the case is removed from the head. In the invention disclosed in Patent Document 1, however, the tubular portion and the connection tube are fixed using only the elastic member, and as such, if an unintended downward force is applied to the filter element, the filter element may fall off from the head.

### SUMMARY OF INVENTION

One or more embodiments of the present invention are to provide a filtering device and a mounting structure with which the filter element does not fall off in an unintended situation.

A filtering device according to one or more embodiments of the present invention includes: a fixing member; a filter element including a filtering member having a cylindrical shape and a plate provided at one end of the filtering member; a valve provided at the fixing member or the filter element; and a sealing member having an annular shape and provided at the fixing member or the filter element, in which a first tubular portion including a protruding portion is provided at one of the fixing member and the plate, and a second tubular portion including a recessed portion into which the protruding portion is inserted is provided at the other of the fixing member and the plate, the recessed portion has a shape in which a first recessed portion with one end opening at an opening edge of the second tubular portion, and a second recessed portion extending along a circumferential direction are coupled with each other, the protruding portion is inserted into the recessed portion when one of the first tubular portion and the second tubular portion is inserted into the other of the first tubular portion and the second tubular portion, and when the protruding portion is inserted into the first recessed portion from the opening edge, moved along the first recessed portion, and moved along the second recessed portion, the first tubular portion and the second tubular portion are mounted, the valve is inserted into the first tubular portion and the second tubular portion, and the sealing member is provided between the first tubular portion and the second tubular portion.

A mounting structure according to one or more embodiments of the present invention is configured to mount a fixing member and a filter element, the filter element including a filtering member having a cylindrical shape and a plate provided at one end of the filtering member, in which a first tubular portion including a protruding portion is provided at one of the fixing member and the plate, and a second tubular portion including a recessed portion into which the protruding portion is inserted is provided at the other of the fixing member and the plate, the recessed portion has a shape in which a first recessed portion with one end opening at an opening edge of the second tubular portion, and a second recessed portion extending along a circumferential direction are coupled with each other, the protruding portion is inserted into the recessed portion when one of the first tubular portion and the second tubular portion is inserted into the other of the first tubular portion and the second tubular portion, and when the protruding portion is inserted into the first recessed portion from the opening edge, moved along the first recessed portion, and moved along the second recessed portion, the first tubular portion and the second tubular portion are mounted, a valve is inserted into the first tubular portion and the second tubular portion, and a sealing member having an annular shape is provided between the first tubular portion and the second tubular portion.

With the filtering device and the mounting structure according to one or more embodiments of the present invention, when one of the first tubular portion and the second tubular portion is inserted into the other, the protruding portion is inserted into the first recessed portion from the opening edge, the protruding portion is moved along the first recessed portion, and then the protruding portion is moved along the second recessed portion, the first tubular portion and the second tubular portion are mounted, the valve is inserted into the first tubular portion and the second tubular portion, and the sealing member is provided between the first tubular portion and the second tubular portion. In this manner, it is possible to prevent the filter element from falling off in an unintended situation. In addition, the sealing member can prevent leakage of liquid when the valve opens.

The plate may include the first tubular portion, the fixing member may include the second tubular portion, the second tubular portion may be inserted into a hollow portion of the first tubular portion, the valve may be inserted into a hollow portion of the second tubular portion, the plate may be formed by bending a plate-shaped member, and includes a body portion and a fixing portion fixed to the body portion, the body portion including a portion having an annular shape, and the protruding portion may be a portion of the fixing portion. Since the plate is manufactured by means of a press or the like in this manner, a molding die is unnecessary. In addition, as compared with manufacturing using a casting mold or the like, the manufacturing by means of a press enables a thin plate shape, thereby reducing the irregularities and the installation space required.

A wall thickness of the second tubular portion may be greater than a wall thickness of the plate-shaped member. This can make the second tubular portion robust and reliably deform the sealing member, thereby achieving high sealing performance.

The protruding portion may include a first protruding portion and a second protruding portion higher than the first protruding portion, a third recessed portion deeper than the second recessed portion may be provided at an end of the second recessed portion on a side not coupled with the first recessed portion, a depth of the second recessed portion may be equal to or greater than a height of the first protruding portion, a depth of the third recessed portion may be equal to or greater than a height of the second protruding portion, and in a state where the first tubular portion and the second tubular portion are fixed, the first protruding portion may be inserted inside the second recessed portion, and the second protruding portion is inserted inside the third recessed portion. In this manner, it is possible to prevent relative rotation of the first tubular portion and the second tubular portion when the first tubular portion and the second tubular portion are mounted.

An inner diameter of a hollow portion of the first tubular portion may be greater than a diameter of a hollow portion of the second tubular portion, the second tubular portion may be inserted into the hollow portion of the first tubular portion, the depth of the second recessed portion may be smaller than the height of the second protruding portion, and a wall thickness of the first tubular portion may be smaller than a wall thickness of the second tubular portion. In this manner, when the protruding portion moves along the second recessed portion, the first tubular portion can be easily deformed.

The second tubular portion may include a groove where the sealing member is provided, and the groove may be provided adjacent to the second recessed portion over an entire circumference in the circumferential direction. In this manner, the sealing member can be reliably deformed, thereby achieving high sealing performance. In addition, since the first tubular portion and the second tubular portion can be manufactured as molded products, mass production is facilitated.

According to one or more embodiments of the present invention, it is possible to prevent the filter element from falling off in an unintended situation.

### BRIEF DESCRIPTION OF DRAWINGS

FIG. 1 is a diagram schematically illustrating a filtering device 1, in which (A) is a plan view (as viewed from above in the vertical direction), and (B) is a front view.

FIG. 2 is a perspective view schematically illustrating the filtering device 1.

FIG. 3 is a diagram schematically illustrating a plate 12, in which (A) is a perspective view, (B) is a plan view (as viewed from above (+z-direction)), and (C) is a sectional view taken along the line A-A of (B).

FIG. 4 is a front view schematically illustrating a fixing member 20 and a valve 30.

FIG. 5 is a sectional view schematically illustrating the fixing member 20 and the valve 30.

FIG. 6 is a sectional view schematically illustrating a fixing member 20D and a valve 30B according to a variation.

FIG. 7 is a sectional view schematically illustrating a main portion of a filtering device 2.

FIG. 8 is an exploded perspective view schematically illustrating a main portion of the filtering device 2.

FIG. 9 is a perspective view schematically illustrating a filtering device 3.

FIG. 10 is a perspective view schematically illustrating the filtering device 3.

FIG. 11 is a diagram schematically illustrating a plate 12B, in which (A) is a perspective view, (B) is a plan view (as viewed from above (+z-direction)), (C) is a bottom view (as viewed from below (-z-direction)), and (D) is a sectional view along a surface P of (A).

FIG. 12 is a sectional view schematically illustrating a fixing member 20B and a valve 30A.

FIG. 13 is a diagram schematically illustrating the fixing member 20B, in which (A) is a plan view, (B) is a front view, and (C) is a sectional view taken along the line A-A of (B).

FIG. 14 is a diagram schematically illustrating a flow of assembling the filtering device 3, in which (A) illustrates a state before a filter element 10B and the fixing member 20B are assembled, (B) illustrates a state during assembly of the filter element 10B and the fixing member 20B, and (C) illustrates a state after the filter element 10B and the fixing member 20B are assembled.

FIG. 15 is a diagram schematically illustrating a flow of assembling the filtering device 3, in which (A) illustrates a state before the filter element 10B and the fixing member 20B are assembled, (B) illustrates a state during assembly of the filter element 10B and the fixing member 20B, and (C) illustrates a state after the filter element 10B and the fixing member 20B are assembled.

FIG. 16 is a perspective view schematically illustrating a filtering device 4.

FIG. 17 is a perspective view schematically illustrating the filtering device 4.

FIG. 18 is a diagram schematically illustrating a plate 12C, in which (A) is a front view, and (B) is a sectional view taken along the line E-E of (A).

FIG. 19 is a diagram schematically illustrating a flow of assembling the filtering device 4, in which (A) illustrates a state before a filter element 10C and a fixing member 20C are assembled, (B) illustrates a state during assembly of the filter element 10C and the fixing member 20C, and (C) illustrates a state after the filter element 10C and the fixing member 20C are assembled.

FIG. 20 is a diagram schematically illustrating a flow of assembling the filtering device 4, in which (A) illustrates a state before the filter element 10C and the fixing member 20C are assembled, (B) illustrates a state during assembly of the filter element 10C and the fixing member 20C, and (C) illustrates a state after the filter element 10C and the fixing member 20C are assembled.

### DESCRIPTION OF EMBODIMENTS

Embodiments of the present invention will be described below in detail with reference to the drawings. A filtering device of the present invention eliminates, using a filter, dust contained in liquids such as oil and water, water contained in oil, and oil mist and dust contained in gases such as air. In addition, a mounting structure of the present invention is a mounting structure for mounting a fixing member and a filter element including a filtering member (for eliminating dust contained in a liquid such as oil and/or a gas such as air) and a plate. The filtering device and the mounting structure of the present invention are also applicable to members such as a line filter installed in a hydraulic circuit and an air breather provided in a tank or the like. The line filter is, for example, a filter installed on a pump discharge side of the hydraulic circuit. The air breather is, for example, a device that eliminates dust and oil mist in air during intake and exhaust due to an increase or decrease in the amount of liquid in the tank.

### First Embodiment

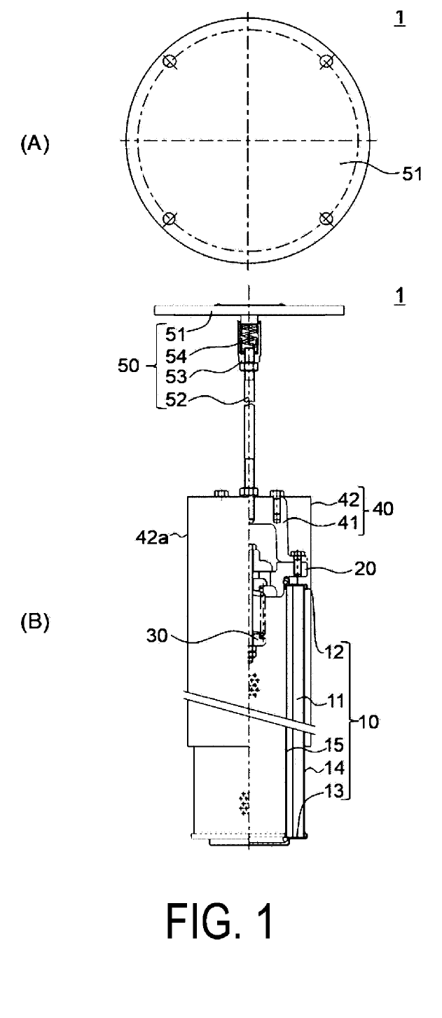

FIG. 1 is a diagram schematically illustrating a filtering device 1, in which (A) is a plan view (as viewed from above in the vertical direction), and (B) is a front view. FIG. 1(B) includes a cross-sectional portion (hatching for the cross section is omitted). The filtering device 1 is, for example, a filter for filtering oil, and is provided inside a tank (omitted in the drawing).

The filtering device 1 mainly includes a filter element 10, a fixing member 20, a valve 30, a cover portion 40, and a mounting portion 50.

The fixing member 20 is mounted to the filter element 10. Fixing of the filter element 10 and the fixing member 20 will be described below. The cover portion 40 is attached to the fixing member 20.

The cover portion 40 is mounted to the fixing member 20. The cover portion 40 includes a coupling portion 41 fixed to the fixing member 20 and a cover 42. The cover 42 includes a tubular portion 42a, and the coupling portion 41, the fixing member 20, and a portion of the filter element 10 are inserted inside the tubular portion 42a.

The mounting portion 50 is mounted to the cover portion 40. The mounting portion 50 includes a plate-shaped portion 51, a shaft 52, a coupling portion 53, and an elastic member 54. The plate-shaped portion 51 is fixed to the top surface (omitted in the drawing) of the tank. The shaft 52 couples the plate-shaped portion 51 (i.e., the tank) and the cover 42 (i.e., the filter element 10) through the coupling portion 53 and the elastic member 54. The elastic member 54 is inserted inside the coupling portion 53, and one end of the elastic member 54 is provided at the plate-shaped portion 51, and the other end is provided at the shaft 52. As a result, the elastic member 54 moves the cover 42 (i.e., the filter element 10) in a direction away from the plate-shaped portion 51, and the filter element 10 is fixed inside the tank.

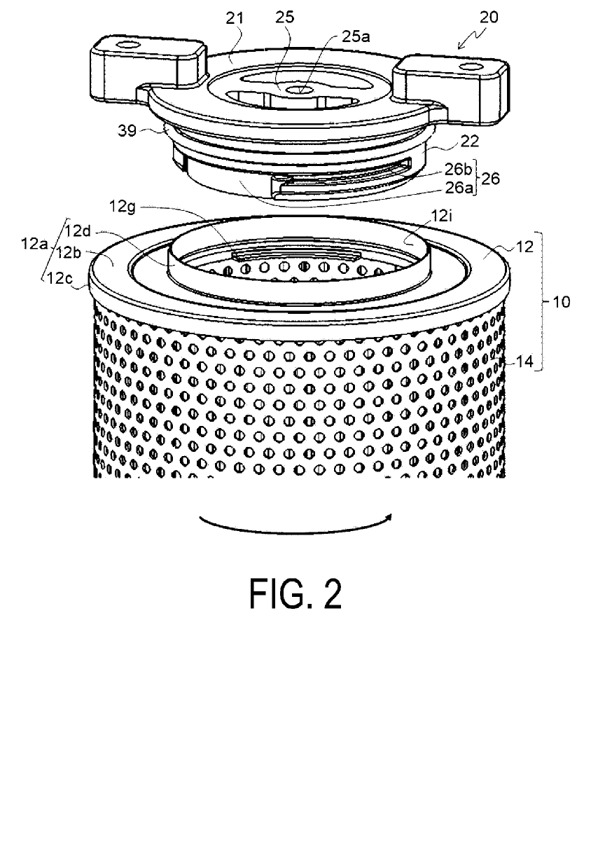

Next, the filter element 10 and the fixing member 20 are described with reference to FIGS. 1(B) and 2. FIG. 2 is a perspective view schematically illustrating the filtering device 1. FIG. 2 illustrates a state where the filter element 10 is removed from the fixing member 20.

The filter element 10 mainly includes a filtering member 11, plates 12 and 13 provided at both ends of the filtering member 11, an outer tube 14, and an inner tube 15.

The filtering member 11 is formed by pleating a sheet-shaped filter paper made of synthetic resin, paper, or the like, and connecting both ends of the pleated filter paper to roll it into a cylindrical shape. The outer tube 14 is provided outside the filtering member 11, and the inner tube 15 is provided inside the filtering member 11. The outer tube 14 and the inner tube 15 are cylindrical members in which a large number of holes through which oil can pass are formed. Note that the outer tube 14 and the inner tube 15 are not essential.

The plate 12 (corresponding to the plate of the present invention) is provided on the upper side of the filtering member 11, the outer tube 14 and the inner tube 15, and the plate 13 is provided on the lower side of the filtering member 11, the outer tube 14, and the inner tube 15. In the present embodiment, the plates 12 and 13 are formed by bending a plate-shaped metal member.

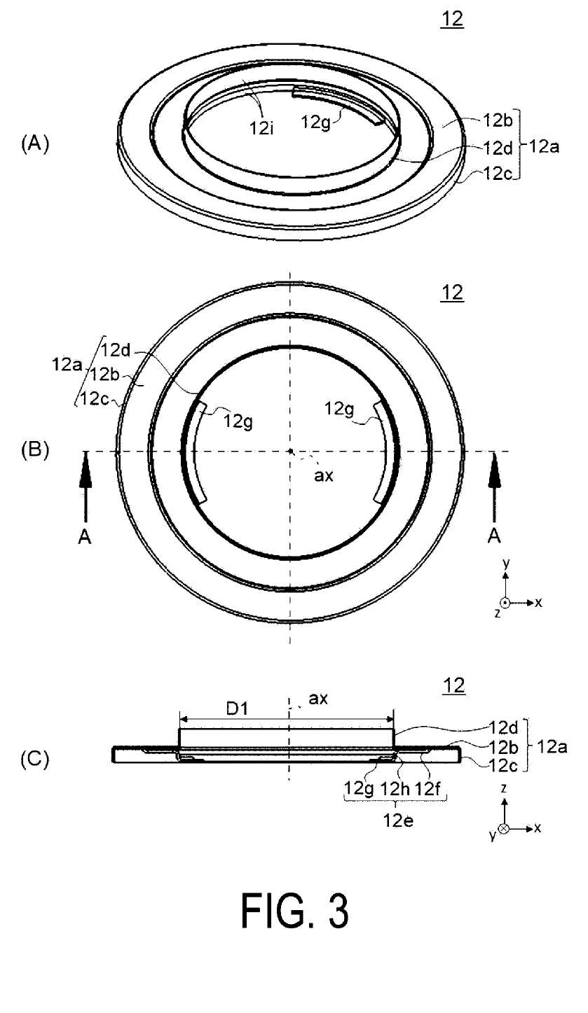

FIG. 3 is a diagram schematically illustrating the plate 12, in which (A) is a perspective view, (B) is a plan view (as viewed from above (+z-direction)), and (C) is a sectional view taken along the line A-A of (B).

The direction along a central axis ax of the filter element 10 is referred to as the z-direction, and the direction orthogonal to the z-direction is referred to as the x-direction and the y-direction. The x-direction and the y-direction are orthogonal to each other.

The plate 12 mainly includes a body portion 12a and a fixing portion 12e. The fixing portion 12e is fixed to the body portion 12a.

The body portion 12a is formed by bending a plate-shaped metal member by press molding. The body portion 12a includes a plate-shaped portion 12b, and tubular portions 12c and 12d. The plate-shaped portion 12b is a plate-shaped member covering the end surface of the filtering member 11 and has an annular shape as viewed from the z-direction. Each of the tubular portions 12c and 12d is provided at the plate-shaped portion 12b. The tubular portion 12c is provided along the outer peripheral edge of the plate-shaped portion 12b, and protrudes in the -z-direction from the plate-shaped portion 12b. The tubular portion 12c is disposed along the outer peripheral surface of the filtering member 11. The tubular portion 12d is provided along the inner peripheral edge of the plate-shaped portion 12b, and protrudes in the +z-direction from the plate-shaped portion 12b.

The fixing portion 12e is formed by bending a plate-shaped metal member by press molding. The fixing portion 12e includes a plate-shaped portion 12f, a protruding portion 12g, and a tubular portion 12h. In other words, the protruding portion 12g is a portion of the fixing portion 12e. The plate-shaped portion 12f is fixed to the -z side surface of the plate-shaped portion 12b. The tubular portion 12h couples the plate-shaped portion 12f and the protruding portion 12g. The tubular portion 12d and the tubular portion 12h have substantially the same diameter, and constitute one tubular portion 12i (corresponding to the first tubular portion of the present invention).

The protruding portion 12g is a rib-shaped protruding portion protruding toward the central axis ax from the inner peripheral surface of the tubular portion 12i. In the present embodiment, two protruding portions 12g (fixing portions 12e) are provided at intervals of 180°, but the positions and the number of the protruding portions 12g (the fixing portions 12e) are not limited thereto.

Description returns to FIGS. 1(B) and 2. The plate 13 has the same configuration as the plate 12, and thus the description thereof will be omitted. It should be noted that the plate 13 is different from the plate 12 in that the plate 13 does not include the protruding portion 12g.

The fixing member 20 mainly includes a plate-shaped portion 21 having a plate-shaped shape, and a tubular portion 22 having a tubular shape. The fixing member 20 is provided with the valve 30. The valve 30 is inserted into the filter element 10 in the state where the filter element 10 and the fixing member 20 are fixed.

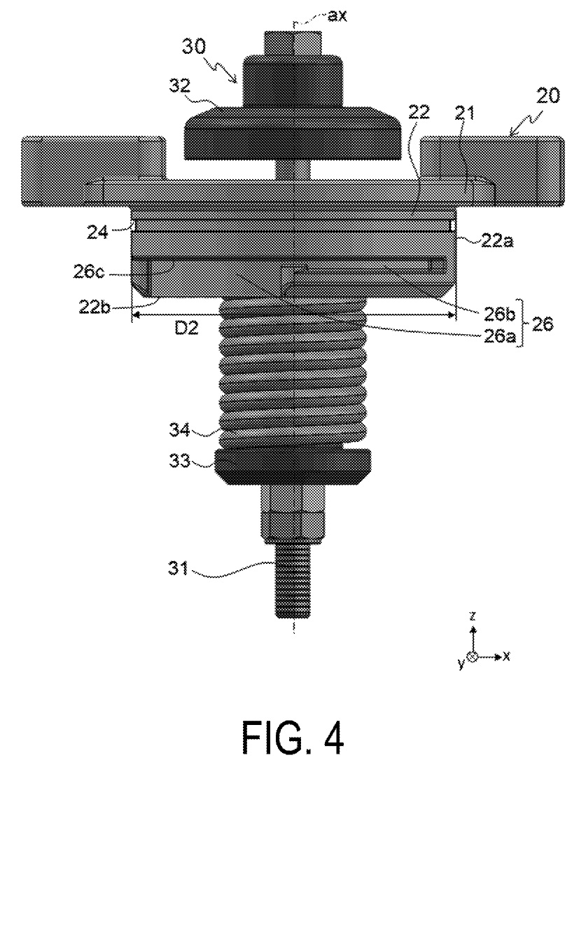

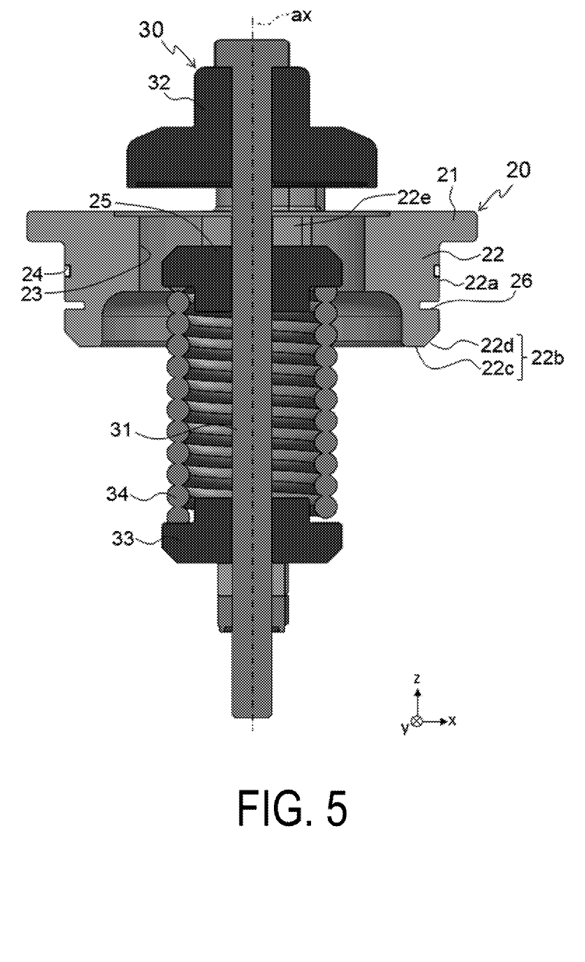

FIG. 4 is a front view schematically illustrating the fixing member 20 and the valve 30. FIG. 5 is a sectional view schematically illustrating the fixing member 20 and the valve 30. In the fixing member 20, a hole 23 that penetrates the fixing member 20 in the thickness direction is formed. The hole 23 penetrates the plate-shaped portion 21 and the tubular portion 22. Inside the hole 23, a holding portion 25 for holding the valve 30 is provided at the tubular portion 22 through a coupling portion 22e.

A groove 24 is provided in an outer peripheral surface 22a of the tubular portion 22 (corresponding to the second tubular portion of the present invention). The groove 24 is provided over the entire circumference in the circumferential direction at a position farther from an opening edge 22b of the tubular portion 22 than a recessed portion 26 (in particular, a second recessed portion 26b (described below)). Note that the opening edge 22b is a concept that includes a flat surface 22c at an end and a chamfered portion 22d formed adjacent to the flat surface 22c.

The recessed portion 26 is provided in the outer peripheral surface 22a of the tubular portion 22. The protruding portion 12g is inserted into the recessed portion 26. The recessed portion 26 mainly includes a first recessed portion 26a and a second recessed portion 26b.

The first recessed portion 26a extends along the central axis ax, with one end opening at the opening edge 22b of the tubular portion 22. The second recessed portion 26b is formed along the circumferential direction. The recessed portion 26 is formed by the first recessed portion 26a and the second recessed portion 26b coupled with each other. The recessed portion 26 has an L-shape as viewed from the direction orthogonal to the central axis ax.

The valve 30 is inserted into the hole 23 and is provided in the holding portion 25. The valve 30 mainly includes a rod-shaped member 31, a valve element 32, a holding portion 33, and an elastic member 34. The rod-shaped member 31 is inserted into a hole 25a (see FIG. 2) of the holding portion 25, whereby the rod-shaped member 31 is movably provided at the holding portion 25. The valve element 32 and the holding portion 33 are fixed to the rod-shaped member 31. The elastic member 34 has both ends provided on the holding portion 25 and the holding portion 33, respectively.

FIGS. 4 and 5 illustrate a state where the valve 30 is open. With the elastic member 34, a force in the -z-direction is applied to the holding portion 33, that is, the rod-shaped member 31 and the valve element 32, and the valve element 32 is in contact with the holding portion 25 (valve seat). When the inner pressure of the filter element 10 increases, the rod-shaped member 31, the valve element 32 and the holding portion 33 move in the +z-direction against the biasing force of the elastic member 34, and the valve element 32 separates from the holding portion 25, thereby opening the valve 30.

Next, assembly of the filtering device 1 is described. Before assembly, the filter element 10 and the fixing member 20 are separated from each other, and therefore the protruding portion 12g is not inserted inside the recessed portion 26 as illustrated in FIG. 2.

To assemble the filter element 10 and the fixing member 20, first, the protruding portion 12g is inserted into the first recessed portion 26a from the opening edge 22b. Thereafter, the protruding portion 12g is slid along the first recessed portion 26a to bring the protruding portion 12g into contact with an end portion 26c (see FIG. 4). As a result, the tubular portion 12i is inserted into the tubular portion 22. An inner diameter D1 of the hollow portion of the tubular portion 12i (see FIG. 3) is greater than a diameter D2 of the tubular portion 22 (see FIG. 4), and therefore the tubular portion 22 can be inserted into the hollow portion of the tubular portion 12i.

Since the first recessed portion 26a and the second recessed portion 26b are coupled with each other at and near the end portion 26c, the filter element 10 and the fixing member 20 can be relatively rotated in the state where the protruding portion 12g is located near the end portion 26c. For example, with respect to the fixing member 20, the filter element 10 is rotated (counterclockwise in FIG. 2) (see the arrow in FIG. 2). As a result, the protruding portion 12g is inserted into the second recessed portion 26b, and the filter element 10 is mounted to the fixing member 20.

In addition, since the groove 24 is provided with a sealing member 39 (see FIG. 2), the sealing member 39 is provided between the filter element 10 and the fixing member 20 in the state where the filter element 10 is fixed to the fixing member 20. In the filtering device 1, the valve 30 is provided inside the tubular portion 12i and the tubular portion 22, and therefore it is essential to prevent leakage of liquid when the valve 30 opens. The sealing member 39 can provide a seal such that liquid does not leak to the outside from between the filter element 10 and the fixing member 20 even when the valve 30 opens.

Once the filter element 10 and the fixing member 20 have been assembled in the above-mentioned manner, the filtering device 1 becomes usable by mounting the fixing member 20 to the cover portion 40. Since the filtration performance of the filtering member 11 gradually decreases as it filters the liquid, the filter element 10 is replaced periodically or as necessary.

First, the fixing member 20 is removed from the cover portion 40, and the filter element 10 and the fixing member 20 are removed. Thereafter, the filter element 10 is relatively rotated (in a direction opposite to that during assembly) with respect to the fixing member 20, thereby moving the protruding portion 12g along the second recessed portion 26b and placing the protruding portion 12g inside the first recessed portion 26a. Thereafter, the filter element 10 is moved along the central axis ax in a direction away from the fixing member 20, thereby removing the filter element 10 from the fixing member 20. In this manner, replacement of the filter element 10 is completed.

According to the present embodiment, the filter element 10 is mounted to the fixing member 20 by moving the protruding portion 12g along the second recessed portion 26b, that is, rotating the filter element 10 with respect to the fixing member 20, and thus it is possible to prevent the filter element from falling off in an unintended situation.

For example, in the form of mounting the filter element to the fixing member by using the elastic member provided between the tube of the filter element and the tube of the fixing member, or the form of mounting the filter element to the fixing member by fitting the claw of the filter element into the groove of the fixing member, the fixation between the filter element and the fixing member is not firm, and therefore the filter element may fall off from the fixing member when an unintended force is applied to the filter element. In contrast, in the filtering device 1, mounting is performed by rotating the filter element 10 with respect to the fixing member 20, and thus the filter element 10 does not fall off from the fixing member 20 even when an unintended force is applied to the filter element 10.

In addition, when replacing the used filter element 10, the filter element 10 is soaked with oil, and oil and dust remain inside the filter element 10, which makes the filter element 10 considerably heavy. For example, in the form of mounting the filter element to the fixing member by using the elastic member provided between the tube of the filter element and the tube of the fixing member, or the form of mounting the filter element to the fixing member by fitting the claw of the filter element into the groove of the fixing member, the filter element may drop due to the weight of the filter element when the fixing member provided with the filter element is lifted upward. In contrast, in the filtering device 1, since mounting is performed by rotating the filter element 10 with respect to the fixing member 20, the filter element 10 is prevented from dropping when the fixing member 20 provided with the filter element 10 is lifted upward, and thus the filter element 10 and the fixing member 20 can be easily lifted upward.

In addition, according to the present embodiment, the filter element 10 can be mounted to the fixing member 20 by moving the protruding portion 12g along the second recessed portion 26b, and thus mounting can be easily and quickly performed.

In addition, according to the present embodiment, the plate 12 needs to be manufactured by bending a plate-shaped member by means of a press or the like, and as such a molding die is unnecessary. Therefore, it is possible to accommodate products in small lots and in a wide variety of types.

In addition, according to the present embodiment, since the sealing member 39 is inserted into the groove 24 formed in the thick-walled, i.e., robust, tubular portion 22, the sealing member 39 can be reliably deformed, thereby achieving high sealing performance.

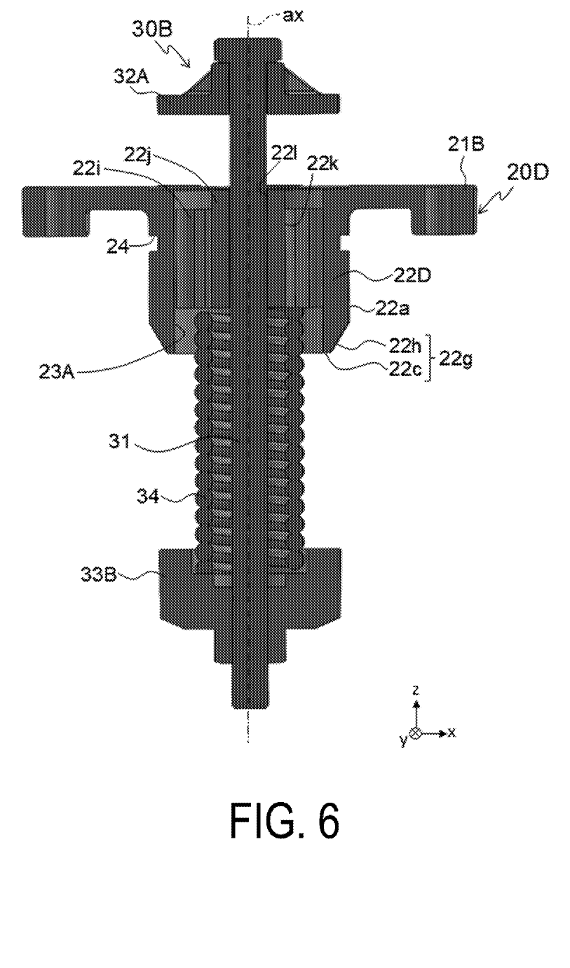

Note that in the present embodiment, the filtering device 1 includes the fixing member 20 and the valve 30, but the configuration of the fixing member and the valve of the filtering device is not limited thereto. FIG. 6 is a sectional view schematically illustrating a fixing member 20D and a valve 30B according to a variation. The fixing member 20D is provided with the valve 30B.

The fixing member 20D mainly includes a plate-shaped portion 21B having a plate-shaped shape, and a tubular portion 22D having a tubular shape. The lower end of the tubular portion 22D is an opening edge 22g (including the flat surface 22c at an end, and a chamfered portion 22h formed adjacent to the flat surface 22c). The plate-shaped portion 21B is provided at the upper end of the tubular portion 22D. In the state where the fixing member 20D is fixed to the filter element 10 (illustration is omitted in FIG. 6), the valve 30B is inserted into the filter element 10.

At the outer peripheral surface 22a of the tubular portion 22D (corresponding to the second tubular portion of the present invention), the groove 24 and the recessed portion 26 (illustration is omitted in FIG. 5) are provided. The hollow portion of the tubular portion 22D is a hole 23A. The hole 23A, which is the hollow portion of the tubular portion 22D, penetrates the fixing member 20D (the plate-shaped portion 21B and the tubular portion 22D) in the thickness direction. The tubular portion 22D includes a holding portion 22i provided inside the hole 23A, and a coupling portion 22j that couples the holding portion 22i and the tubular portion 22D. The holding portion 22i is provided with a plurality of holes 22k penetrating the holding portion 22i in the thickness direction.

The valve 30B is provided at the holding portion 22i. The valve 30B mainly includes the rod-shaped member 31, a valve element 32A, a holding portion 33B, and the elastic member 34. A hole 22l of the holding portion 22i is inserted into the rod-shaped member 31, whereby the rod-shaped member 31 is movably provided at the holding portion 22i. The valve element 32A and the holding portion 33B are fixed to the rod-shaped member 31. Both ends of the elastic member 34 are respectively provided at the holding portion 22i and the holding portion 33B.

FIG. 6 illustrates a state where the valve 30B is open. With the elastic member 34, a force in the -z-direction is applied to the holding portion 33B, that is, the rod-shaped member 31 and the valve element 32A, and the valve element 32A is in contact with the holding portion 22i (valve seat). When the inner pressure of the filter element 10 increases, the rod-shaped member 31, the valve element 32A, and the holding portion 33B move in the +z-direction against the biasing force of the elastic member 34, and the valve element 32A is separated from the holding portion 22i, thereby opening the valve 30B.

According to the present variation, the holding portion 22i and the coupling portion 22j may be integral with the tubular portion 22D (the holding portion 25 needs not to be a member separated from the tubular portion 22 unlike in FIGS. 4 and 5). In addition, since the holding portion 22i has a columnar shape, it is easy to manufacture.

### Second Embodiment

In the first embodiment, the groove 24 where the sealing member 39 is provided is provided in the tubular portion 22, but the way of providing the sealing member 39 is not limited to this. A filtering device 2 according to a second embodiment is described below. Note that the same components as those in the first embodiment are denoted by the same reference numerals, and descriptions thereof will be omitted.

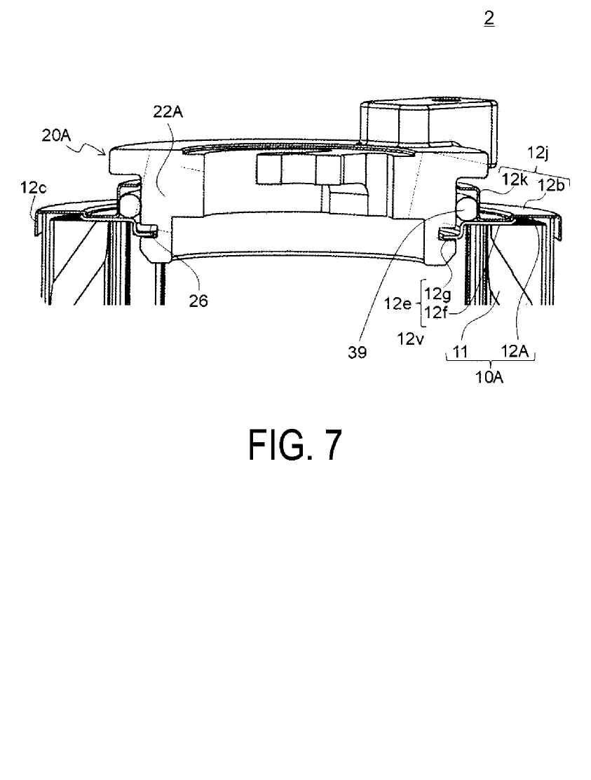

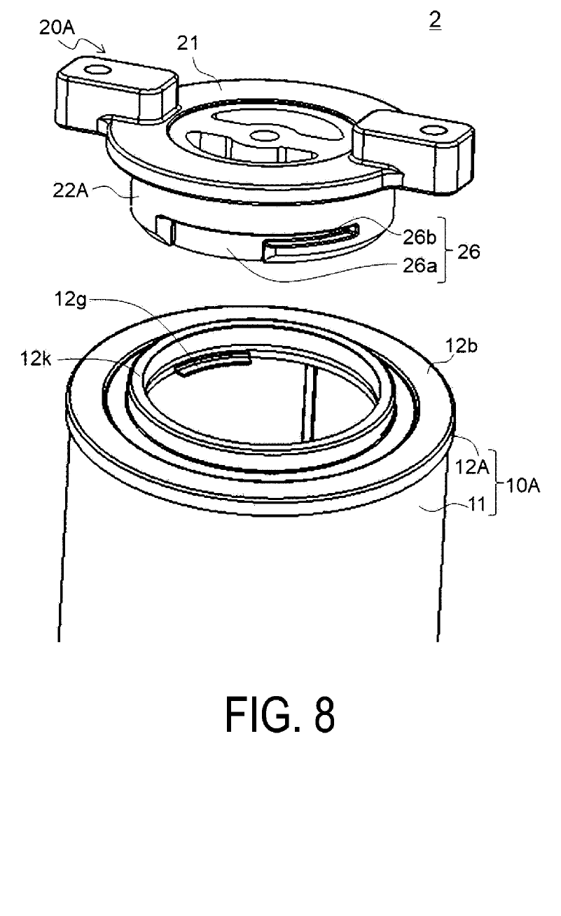

FIGS. 7 and 8 are diagrams schematically illustrating the filtering device 2. FIG. 7 is a sectional view illustrating a main portion of the filtering device 2, and FIG. 8 is an exploded perspective view illustrating a main portion of the filtering device 2.

The filtering device 2 mainly includes a filter element 10A, a fixing member 20A, and a valve (omitted in the drawing). The filter element 10A mainly includes the filtering member 11, and plates 12A and 13 (omitted in the drawing) provided at both ends of the filtering member 11. The fixing member 20A mainly includes the plate-shaped portion 21 having a plate-shaped shape, and a tubular portion 22A having a tubular shape.

The plate 12A, which is formed by bending a plate by means of a press or the like, includes a body portion 12j and the fixing portion 12e. The body portion 12j includes the plate-shaped portion 12b, and tubular portions 12c and 12k. The tubular portion 12k has an L-shape in cross section. The plate-shaped portion 12f of the fixing portion 12e is fixed to the body portion 12j. The sealing member 39 is provided at an annular groove formed by the tubular portion 12k and the fixing portion 12e.

The tubular portion 22A is the same as the tubular portion 22 except that the groove 24 is not provided.

When the filter element 10A is rotated after the protruding portion 12g is moved along the first recessed portion 26a, the protruding portion 12g moves along the second recessed portion 26b, and the filter element 10A is mounted to the fixing member 20A. In the state where the filter element 10A is fixed to the fixing member 20A, the sealing member 39 is provided between the filter element 10A and the fixing member 20A.

According to the present embodiment, the filter element 10A is mounted to the fixing member 20A by moving the protruding portion 12g along the second recessed portion 26b, that is, rotating the filter element 10A with respect to the fixing member 20A, and thus it is possible to prevent the filter element from falling off in an unintended situation. In addition, mounting can be easily and quickly performed.

### Third Embodiment

In the first and second embodiments, the plates 12 and 12A are manufactured by bending a plate-shaped member by means of a press or the like, but the manufacturing method of the plate is not limited to this. In a third embodiment of the present invention, a plate is manufactured through molding. A filtering device 3 according to the third embodiment is described below. Note that the same components as those in the first embodiment are denoted using the same reference numerals, and descriptions thereof will be omitted.

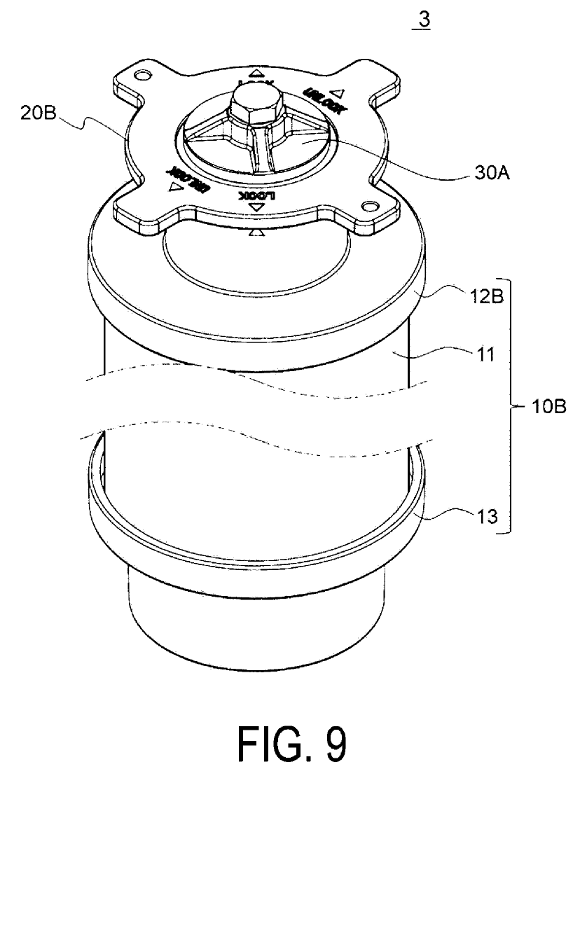

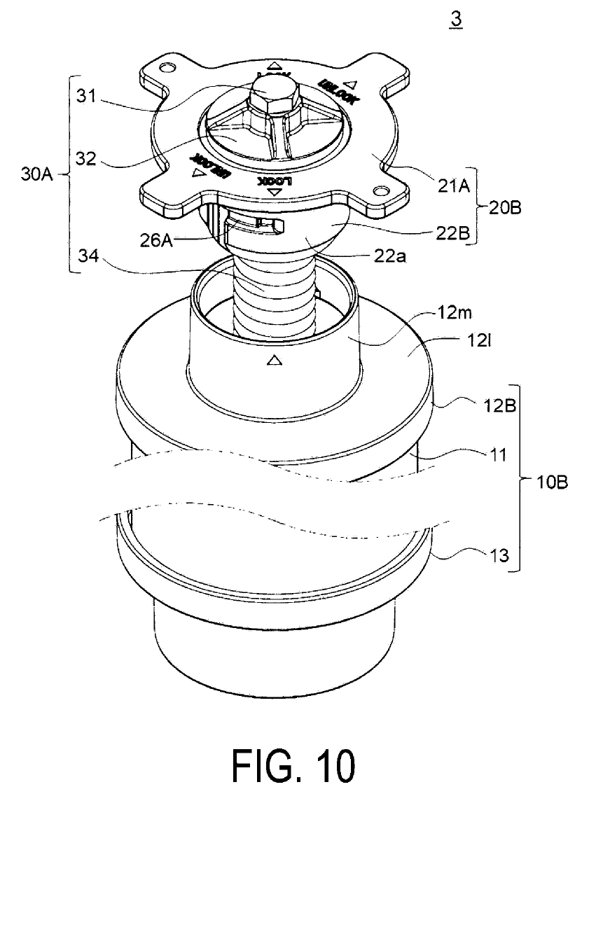

FIGS. 9 and 10 are perspective views schematically illustrating the filtering device 3. The filtering device 3 is, for example, a line filter that filters oil. The filtering device 3 mainly includes a filter element 10B, a fixing member 20B, a valve 30A, and a filter case not illustrated in the drawing. FIG. 9 illustrates a state where the filter element 10B is mounted to the fixing member 20B, and FIG. 10 illustrates a state where the filter element 10B is removed from the fixing member 20B.

The fixing member 20B is included in a body portion provided at a pipe of a hydraulic circuit not illustrated in the drawing. The filter case not illustrated in the drawing is mounted to the body portion. In the filter case, one end of the tubular member is covered, and the other end is open, and a screw portion is formed at the opening edge. When the screw portion of the filter case and a screw portion (not illustrated in the drawing) formed in the body portion are threadedly engaged with each other, a space into which the filter element 10 is inserted is formed. In addition, the body portion is formed with an inlet through which unfiltered oil flows into the internal space, and an outlet through which filtered oil flows out.

The filter element 10B mainly includes the filtering member 11, and plates 12B and 13A provided at both ends of the filtering member 11.

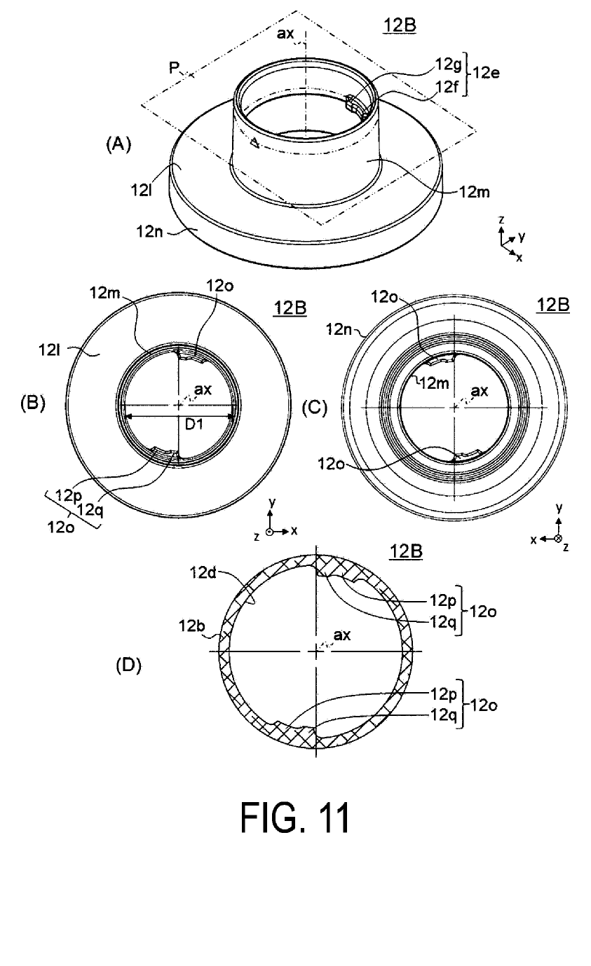

FIG. 11 is a diagram schematically illustrating the plate 12B, in which (A) is a perspective view, (B) is a plan view (as viewed from above (+z-direction)), (C) is a bottom view (as viewed from below (the -z-direction)), and (D) is a sectional view along a surface P of (A).

The plate 12B mainly includes a plate-shaped portion 12l, and tubular portions 12m and 12n. The plate-shaped portion 12l is a plate-shaped member covering the end surface of the filtering member 11 and has an annular shape as viewed from the z-direction. Each of the tubular portions 12m and 12n is provided at the plate-shaped portion 12l.

The tubular portion 12n is provided along the outer peripheral edge of the plate-shaped portion 12l, and protrudes in the -z-direction from the plate-shaped portion 12l. The tubular portion 12n is disposed along the outer peripheral surface of the filtering member 11.

The tubular portion 12m (corresponding to the first tubular portion of the present invention) is provided along the inner peripheral edge of the plate-shaped portion 12l, and protrudes in the +z-direction from the plate-shaped portion 12l. A protruding portion 12o is provided at the inner peripheral surface of the tubular portion 12m.

The protruding portion 12o is a rib-shaped protruding portion protruding toward the central axis ax from the inner peripheral surface of the tubular portion 12m. In the present embodiment, two protruding portions 12o are provided at intervals of 180°, but the positions and the number of the protruding portions 12o are not limited thereto.

The protruding portion 12o includes a protruding portion 12p (corresponding to the first protruding portion of the present invention), and a protruding portion 12q (corresponding to the second protruding portion of the present invention). The height of the protruding portion 12q is greater than the height of the protruding portion 12p. The protruding portion 12p and the protruding portion 12q are adjacent to each other, and in the present embodiment, the protruding portion 12q is formed at an end of the protruding portion 12p.

Description returns to FIGS. 9 and 10. The plate 13A has the same configuration as that of the plate 12B, and therefore the description thereof is omitted. It should be noted that the plate 13A is different from the plate 12B in that the plate 13A does not have a configuration corresponding to the protruding portion 12o.

The fixing member 20B mainly includes a plate-shaped portion 21A having a plate-shaped shape, and a tubular portion 22B having a tubular shape. The fixing member 20B is provided with the valve 30A. In the state where the filter element 10B and the fixing member 20B are fixed, the valve 30A is inserted into the filter element 10B.

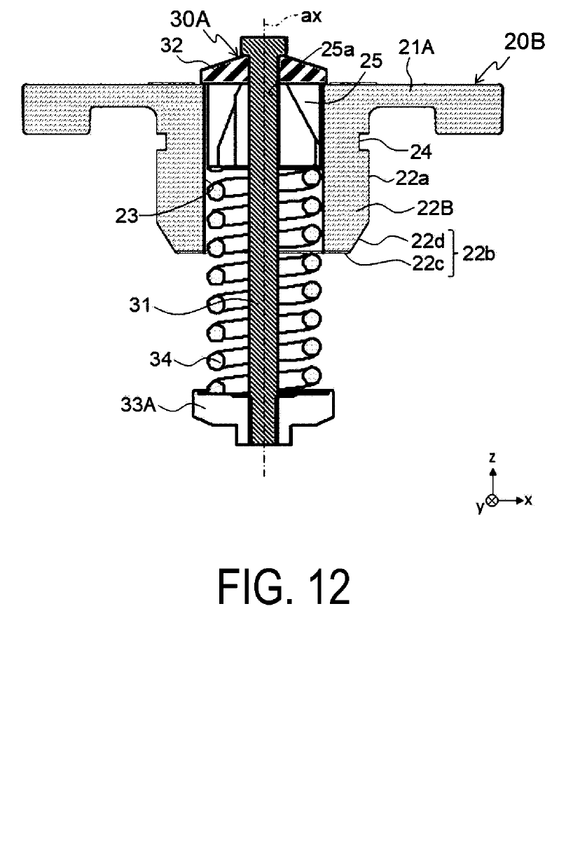

FIG. 12 is a sectional view schematically illustrating the fixing member 20B and the valve 30A. In FIG. 12, hatching for a cross-sectional portion is omitted. In the fixing member 20B, the hole 23 penetrating the fixing member 20B in the thickness direction is formed. The hole 23 penetrates the plate-shaped portion 21A and the tubular portion 22B. The hole 23 is provided with the holding portion 25 that holds the valve 30A.

The groove 24 is provided in the outer peripheral surface 22a of the tubular portion 22B (corresponding to the second tubular portion of the present invention). The groove 24 is provided over the entire circumference in the circumferential direction at a position farther from the opening edge 22b of the tubular portion 22 than a recessed portion 26A (in particular, the second recessed portion 26b (described below)).

The valve 30A is inserted into the hole 23, and provided at the holding portion 25. The valve 30A mainly includes the rod-shaped member 31, the valve element 32, a holding portion 33A, and the elastic member 34. The rod-shaped member 31 is inserted into the hole 25a of the holding portion 25, whereby the rod-shaped member 31 is movably provided at the holding portion 25. The valve element 32 and the holding portion 33A are fixed at the rod-shaped member 31. The elastic member 34 has both ends provided on the holding portion 25 and the holding portion 33, respectively.

FIG. 12 shows a state in which the valve 30 is closed. With the elastic member 34, a force in the -z-direction is applied to the holding portion 33A, that is, the rod-shaped member 31 and the valve element 32, and the valve element 32 is in contact with the holding portion 25 (valve seat). When the inner pressure of the filter element 10B increases, the rod-shaped member 31, the valve element 32 and the holding portion 33 move in the +z-direction against the biasing force of the elastic member 34, and the valve element 32 separates from the holding portion 25, thereby opening the valve 30A.

Description returns to FIGS. 9 and 10. The outer peripheral surface 22a of the tubular portion 22 is provided with the recessed portion 26A. The protruding portion 12o is inserted into the recessed portion 26.

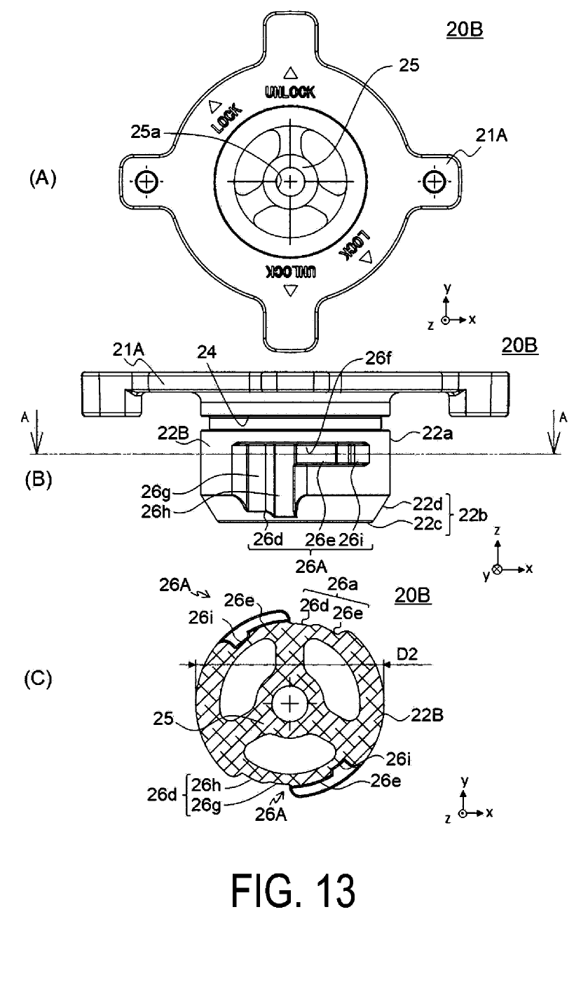

FIG. 13 is a diagram schematically illustrating the fixing member 20B, in which (A) is a plan view, (B) is a front view, and (C) is a sectional view taken along the line A-A of (B).

The recessed portion 26A mainly includes a first recessed portion 26d and a second recessed portion 26e. The first recessed portion 26d extends along the central axis ax, with one end opening at the opening edge 22b. The second recessed portion 26e is formed along the circumferential direction. The recessed portion 26A is formed by the first recessed portion 26d and the second recessed portion 26e coupled with each other. The recessed portion 26A has an L-shape as viewed from the direction orthogonal to the central axis ax.

The end of the recessed portion 26A farthest from the opening edge 22b is an end portion 26f. The end portion 26f includes an end of the first recessed portion 26d on the opposite side of the opening edge 22b, and the surface, of the surfaces extending along the longitudinal direction, of the second recessed portion 26e on the side farther from the opening edge 22b.

The first recessed portion 26d includes a shallow groove portion 26g and a deep groove portion 26h that is deeper than the shallow groove portion 26g. A recessed portion 26i (corresponding to the third recessed portion of the present invention) is formed at the end of the second recessed portion 26e on the side not coupled with the first recessed portion 26d. The recessed portion 26i is included in the second recessed portion 26e extending along the circumferential direction. The recessed portion 26i is deeper than the second recessed portion 26e. The depth of the deep groove portion 26h is greater than the depth of the second recessed portion 26e by a minute amount. In addition, the depth of the second recessed portion 26e is smaller than the height of the protruding portion 12q, and is equal to or greater than the height of the protruding portion 12p. The depth of the recessed portion 26i is equal to or greater than the height of the protruding portion 12g. It should be noted that the depth of the second recessed portion 26e may be substantially same as the depth of the deep groove portion 26h.

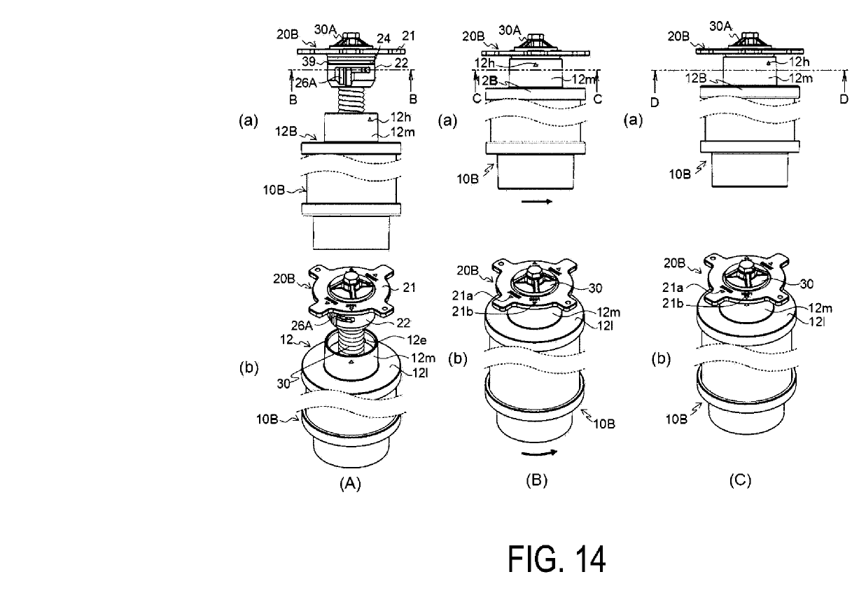

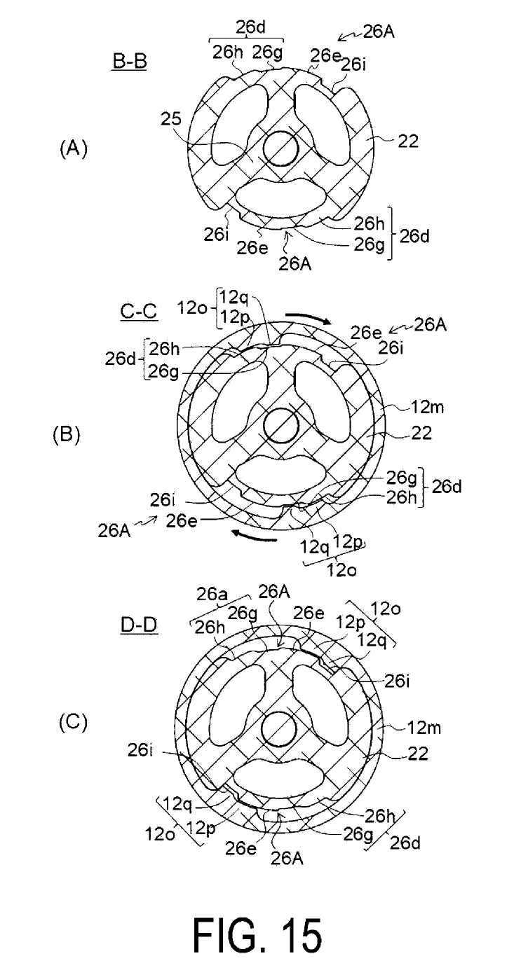

Next, assembly of the filtering device 3 is described. FIGS. 14 and 15 are diagrams schematically illustrating a flow of assembling the filtering device 3. In FIGS. 14 and 15, (A) illustrates a state before the filter element 10B and the fixing member 20B are assembled, (B) illustrates a state during assembly of the filter element 10B and the fixing member 20B, and (C) illustrates a state after the filter element 10B and the fixing member 20B are assembled. In addition, in FIG. 14, (a) is a front view, and (b) is a perspective view as viewed from the front and obliquely above. FIG. 15(A) is a sectional view taken along the line B-B of FIG. 14(A), FIG. 15(B) is a sectional view taken along the line C-C of FIG. 14(B), and FIG. 15(C) is a sectional view taken along the line D-D of FIG. 14(C).

As illustrated in FIGS. 14(A) and 15(A), before assembly, the filter element 10B and the fixing member 20B are separated from each other, and therefore the protruding portion 12o is not inserted inside the recessed portion 26A.

To assemble the filter element 10B and the fixing member 20B, first, the protruding portion 12o is inserted into the first recessed portion 26d from the opening edge 22b. More specifically, the protruding portion 12p is inserted into the shallow groove portion 26g, and the protruding portion 12q is inserted into the deep groove portion 26h. Since the inner diameter D1 (see FIG. 3) of the hollow portion of the tubular portion 12m is greater than the diameter D2 (see FIG. 5) of the tubular portion 22B, the tubular portion 22B is inserted into the hollow portion of the tubular portion 12m. As a result, the protruding portion 12o can be easily inserted into the first recessed portion 26d. In addition, in the filtering device 3, a marking 12r is provided at a position corresponding to the protruding portion 12o for the purpose of improving operability, and thus the protruding portion 12o is inserted into the first recessed portion 26d by aligning the marking 12r and a marking 21a (the first recessed portion 26d). Note that the markings 12r and 21a are not essential. Since the depths of the shallow groove portion 26g and the deep groove portion 26h are greater than the heights of the protruding portion 12p and the protruding portion 12q, respectively, no unnecessary force is applied to the tubular portion 12m.

Thereafter, the protruding portion 12o is slid along the first recessed portion 26d to bring the protruding portion 12o into contact with the end portion 26f (see FIG. 13(B)). This results in the state illustrated in FIGS. 14(B) and 15(B).

Since the first recessed portion 26d and the second recessed portion 26e are coupled at and near the end portion 26f, the filter element 10B and the fixing member 20B can be relatively rotated in the state illustrated in FIGS. 14(B) and 15(B). In the present embodiment, since the fixing member 20B is fixed to a hydraulic circuit or the like, the filter element 10B is rotated (counterclockwise in FIG. 14 and clockwise in FIG. 15) as indicated by the arrows in FIGS. 14(B) and 15(B).

The depth of the second recessed portion 26e is smaller than the height of the protruding portion 12q, and therefore, when the filter element 10B, that is, the protruding portion 12o is rotated from the state illustrated in FIG. 15(B) along the second recessed portion 26e (see the arrow in FIG. 15(B)), the protruding portion 12q goes up onto the second recessed portion 26e. The wall thickness of the tubular portion 12m is smaller than the wall thickness of the tubular portion 22B, and therefore the tubular portion 12m deforms when the protruding portion 12q goes up onto the second recessed portion 26e.

When the filter element 10B is further rotated, the protruding portion 12q is inserted into the recessed portion 26i located at the end of the second recessed portion 26e as illustrated in FIG. 15(C). As a result, the filter element 10B is mounted to the fixing member 20B. In this state where the filter element 10B is fixed to the fixing member 20B, the protruding portion 12p is inserted inside the second recessed portion 26e. Since the depths of the second recessed portion 26e and the recessed portion 26i are greater than the heights of the protruding portion 12p and the protruding portion 12q, respectively, deformation of the tubular portion 12m is eliminated, and no unnecessary force is applied to the tubular portion 12m. In addition, when the protruding portion 12p is inserted into the recessed portion 26i, the marking 12r and a marking 21b overlap each other. Note that the marking 21b is not essential.

In addition, the sealing member 39 is provided at the groove 24 (see (a) of FIG. 7), and therefore, in the state where the filter element 10B is fixed to the fixing member 20B, the sealing member 39 is provided between the filter element 10B and the fixing member 20B. In the filtering device 3, the valve 30A is provided inside the tubular portion 12m and the tubular portion 22B, and therefore it is essential to prevent leakage of liquid when the valve 30A opens. The sealing member 39 can provide a seal such that liquid does not leak to the outside from between the filter element 10B and the fixing member 20B even when the valve 30A opens.

In this manner, once the filter element 10B and the fixing member 20B are assembled, the filtering device 3 becomes usable by mounting the filter case to the body portion (including the fixing member 20B). Since the filtration performance of the filtering member 11 gradually decreases as it filters the liquid, the filter element 10B is replaced periodically or as necessary.

First, the filter case is removed from the body portion to expose the filter element 10B. Thereafter, the filter element 10B is rotated clockwise as viewed from the front side (in a direction opposite to that during assembly), thereby moving the protruding portion 12o along the second recessed portion 26e and placing the protruding portion 12o inside the first recessed portion 26d. Thereafter, the filter element 10B is moved in a direction away from the fixing member 20B along the central axis ax, thereby removing the filter element 10B from the fixing member 20B. Thus, replacement of the filter element 10B is completed.

According to the present embodiment, the filter element 10B is mounted to the fixing member 20B by moving the protruding portion 12o along the second recessed portion 26e, that is, rotating the filter element 10B with respect to the fixing member 20B, and thus it is possible to prevent the filter element from falling off in an unintended situation.

In addition, according to the present embodiment, the filter element 10B can be mounted to the fixing member 20B by moving the protruding portion 12o along the second recessed portion 26e, and thus mounting can be easily and quickly performed.

In addition, according to the present embodiment, the protruding portion 12q is inserted into the recessed portion 26i when the filter element 10B is mounted to the fixing member 20B, and thus the filter element 10 can be prevented from rotating after assembly. In addition, since deformation of the tubular portion 12m is restored when the protruding portion 12p is inserted into the recessed portion 26i, the mounting operator can easily determine the completion of mounting.

Note that in the present embodiment, the protruding portion 12o is provided at the tubular portion 12m on the outside and the recessed portion 26A is provided at the tubular portion 22B on the inside, but a recessed portion may be provided at the tubular portion 12m on the outside and the protruding portion 12g may be provided at the tubular portion 22 on the inside.

In addition, in the present embodiment, the protruding portion 12q and the recessed portion 26i are provided such that the protruding portion 12q is inserted into the recessed portion 26i when the filter element 10B is mounted to the fixing member 20B, but the protruding portion 12q and the recessed portion 26i are not essential.

### Fourth Embodiment

In the present embodiment, the valve 30A is provided at the fixing member 20B, but the valve 30A needs only to be provided inside the tubular portion 12m and the tubular portion 22B, and the position of the valve 30A is not limited to this.

A filtering device 4 according to a fourth embodiment of the present invention has a configuration in which a valve is provided at a filter element. The filtering device 4 is described below. Note that the same components as those of the filtering device 3 are denoted using the same reference numerals, and descriptions thereof will be omitted.

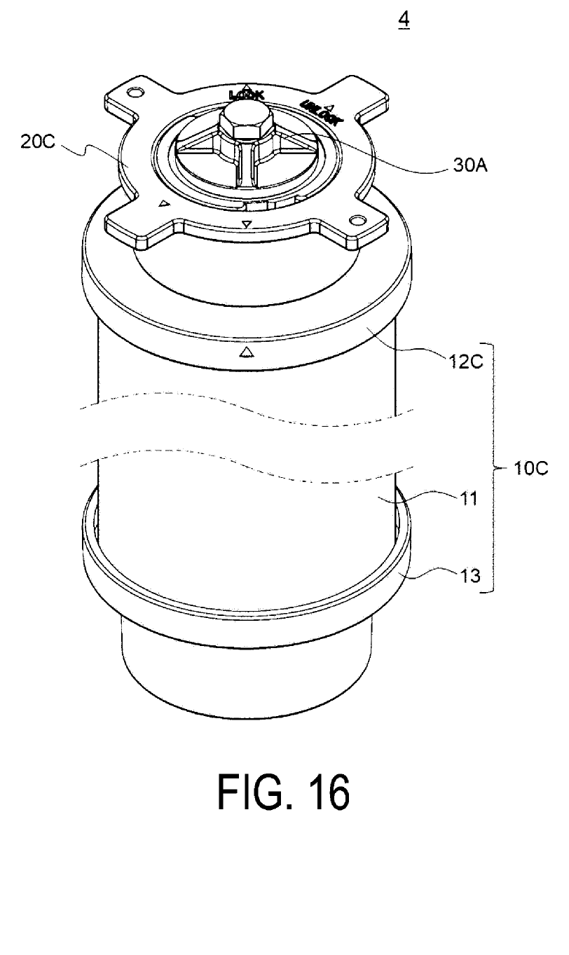

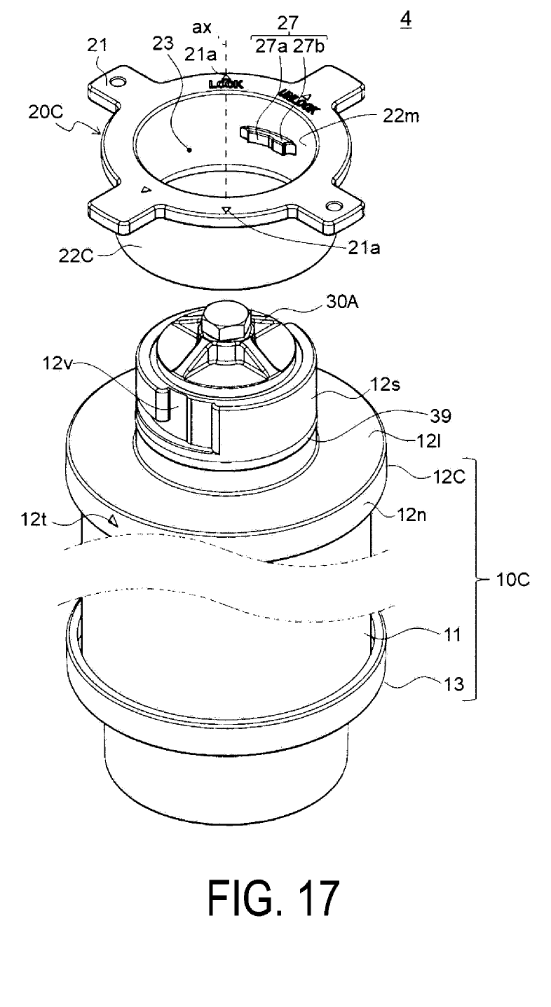

FIGS. 16 and 17 are perspective views schematically illustrating the filtering device 4. The filtering device 4 is an air breather, for example. The filtering device 4 mainly includes a filter element 10C, a fixing member 20C, the valve 30A, and a filter case not illustrated in the drawing. FIG. 16 illustrates a state where the filter element 10C is mounted to the fixing member 20C, and FIG. 17 illustrates a state where the filter element 10C is removed from the fixing member 20C.

The fixing member 20C is included in a body portion provided in a tank or the like. The body portion and the filter case are the same as those of the filtering device 3.

The filter element 10C mainly includes the filtering member 11, and plates 12C and 13 provided at both ends of the filtering member 11. As with the plate 12, the plate 12C (corresponding to the plate of the present invention) is provided on the upper side of the filtering member 11.

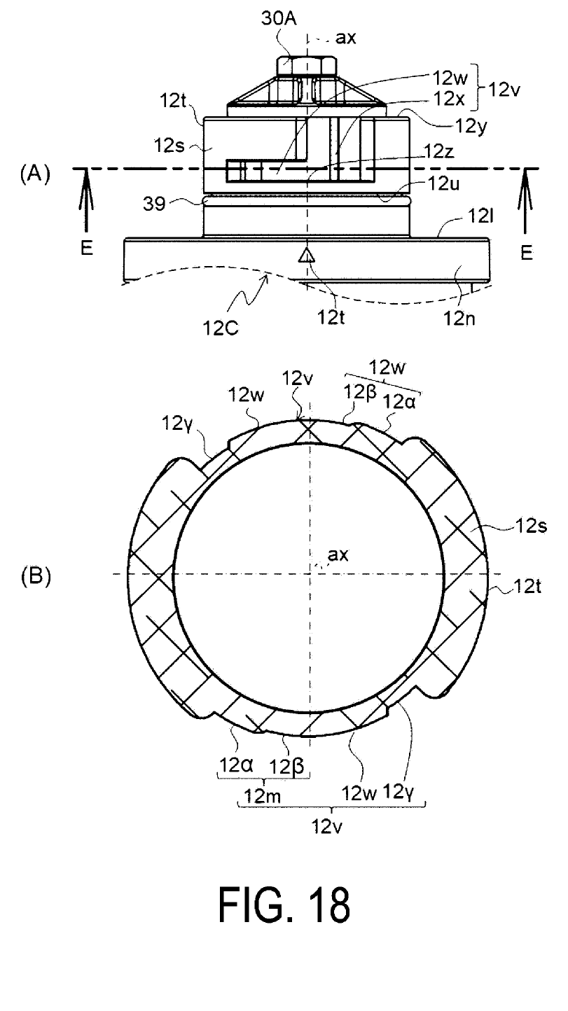

FIG. 18 is a diagram schematically illustrating the plate 12C, in which (A) is a front view, and (B) is a sectional view taken along the line E-E of (A). Note that FIG. 11(A) also illustrates the valve 30A for the sake of explanation. In FIG. 11(B), only a main portion is illustrated.

The plate 12C mainly includes the plate-shaped portion 12l and tubular portions 12n and 12s. The tubular portion 12s (corresponding to the second tubular portion of the present invention) is provided along the inner peripheral edge of the plate-shaped portion 12l, and protrudes in the +z-direction from the plate-shaped portion 12l. The valve 30A is inserted into and fixed to the hollow portion of the tubular portion 12s. The structure for mounting the valve 30A is the same as that of the filtering device 3, and therefore the description thereof is omitted.

A groove 12u is provided in an outer peripheral surface 12t of the tubular portion 12s. The groove 12u is provided near the plate-shaped portion 12l over the entire circumference in the circumferential direction. The sealing member 39 is provided at the groove 12u. In addition, a recessed portion 12v is formed in the outer peripheral surface 12t.

The recessed portion 12v has the same configuration as that of the recessed portion 26A. The recessed portion 12v mainly includes a first recessed portion 12w and a second recessed portion 12x. The first recessed portion 12w extends along the central axis ax, with one end opening at an opening edge 12y of the tubular portion 12s. The second recessed portion 12x is formed along the circumferential direction. The recessed portion 12v is formed by the first recessed portion 12w and the second recessed portion 12x coupled with each other. The recessed portion 12v has an L-shape as viewed from the direction orthogonal to the central axis ax. The end of the recessed portion 12v farthest from the opening edge 12y is an end portion 12z. The end portion 12z includes an end of the first recessed portion 12w on the opposite side of the opening edge 12y, and the surface, of the surfaces extending along the longitudinal direction, of the second recessed portion 12x on the side farther from the opening edge 12y.

The first recessed portion 12w includes a shallow groove portion 12α and a deep groove portion 12β deeper than the shallow groove portion 12α. A recessed portion 12γ (corresponding to the third recessed portion of the present invention) is formed at the end of the second recessed portion 12x on the side not coupled with the first recessed portion 12w. The recessed portion 12γ is deeper than the second recessed portion 12x. It should be noted that the recessed portion 12γ is not essential.

Description returns to FIGS. 16 and 17. The fixing member 20C mainly includes the plate-shaped portion 21A having a plate-shaped shape, and a tubular portion 22C having a tubular shape. The inner diameter of the hollow portion (the hole 23) of the tubular portion 22C is greater than the diameter of the tubular portion 12s. In the state where the filter element 10C and the fixing member 20C are assembled, the tubular portion 12s is inserted inside the hole 23.

A protruding portion 27 is provided at an inner peripheral surface 22m of the tubular portion 22C (corresponding to the first tubular portion of the present invention). The protruding portion 27 has the same configuration as that of the protruding portion 12o. The protruding portion 27 is a rib-shaped protruding portion protruding toward the central axis ax the inner peripheral surface 22m. The protruding portion 27 includes a protruding portion 27a (corresponding to the first protruding portion of the present invention) and a protruding portion 27b (corresponding to the second protruding portion of the present invention). The height of the protruding portion 27b is greater than the height of the protruding portion 27a. The protruding portion 27a and the protruding portion 27b are adjacent to each other, and in the present embodiment, the protruding portion 27b is formed at an end of the protruding portion 27a. It should be noted that the protruding portion 27b is not essential.

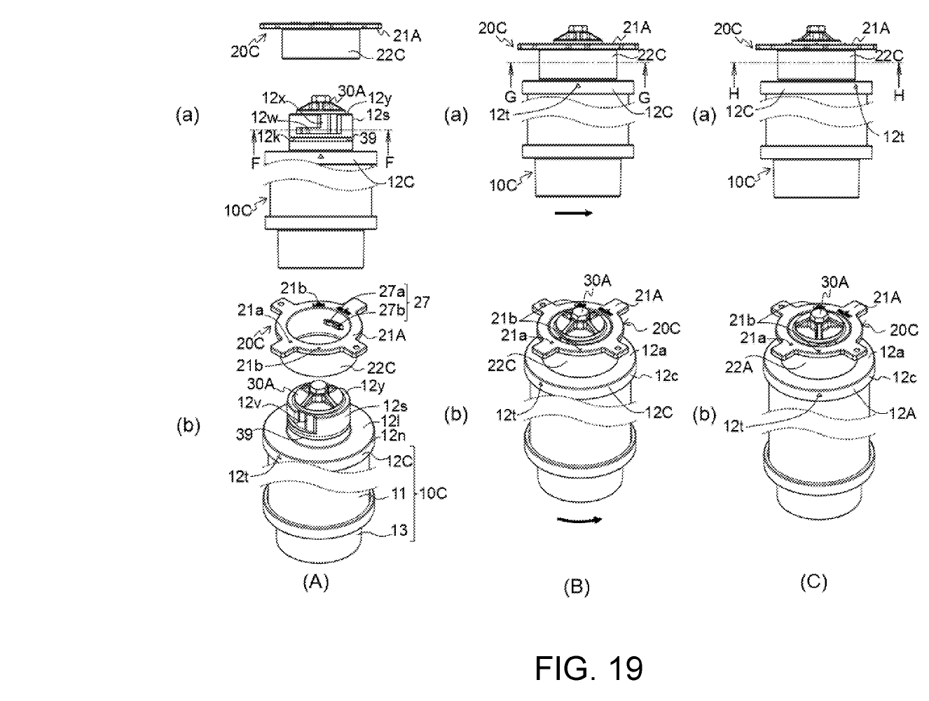

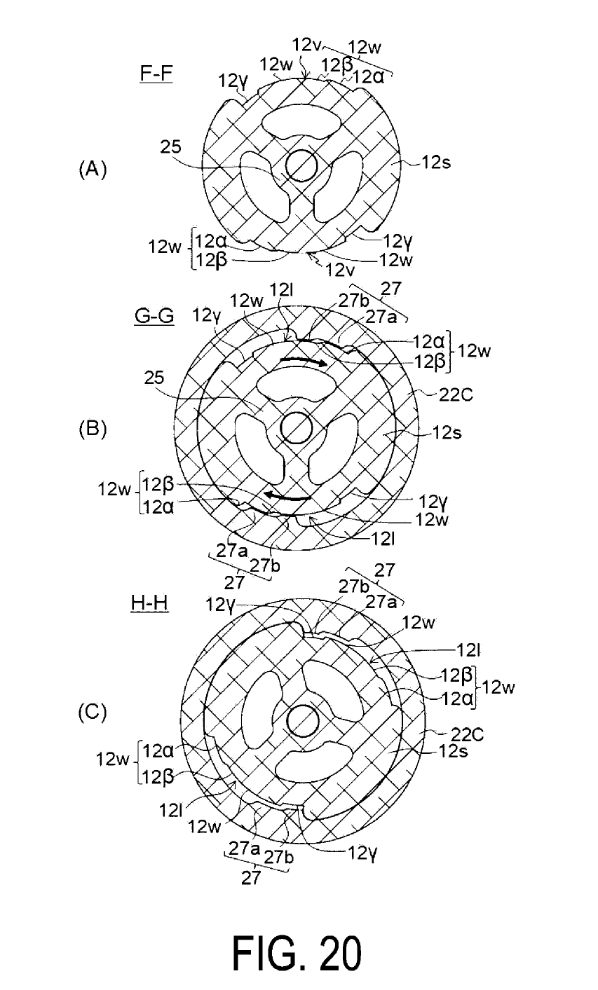

Next, assembly of the filtering device 4 is described. FIGS. 19 and 20 are diagrams schematically illustrating a flow of assembling the filtering device 4. In FIGS. 19 and 20, (A) illustrates a state before the filter element 10C and the fixing member 20C are assembled, (B) illustrates a state during assembly of the filter element 10C and the fixing member 20C, and (C) illustrates a state after the filter element 10C and the fixing member 20C are assembled. In addition, in FIG. 19, (a) is a front view, and (b) is a perspective view as viewed from the front and obliquely above. FIG. 20(A) is a sectional view taken along the line F-F of FIG. 19(A), FIG. 20(B) is a sectional view taken along the line G-G of FIG. 19(B), and FIG. 20(C) is a sectional view taken along the line H-H of FIG. 19(C).

As illustrated in FIGS. 19(A) and 20(A), before assembly, the filter element 10C and the fixing member 20C are separated from each other, and therefore the protruding portion 27 is not inserted inside the recessed portion 12v.

To start assembling the filter element 10C and the fixing member 20C, the protruding portion 27 is inserted into the first recessed portion 12w from the opening edge 12y. More specifically, the protruding portion 27a is inserted into the shallow groove portion 12, and the protruding portion 27b is inserted into the deep groove portion 12β. Since the inner diameter of the hollow portion of the tubular portion 22C is greater than the diameter of the tubular portion 12s, the tubular portion 12s is inserted into the hollow portion of the tubular portion 22C. In addition, in the filtering device 4, markings 12δ and 21a are provided at positions corresponding to the first recessed portion 12w for the purpose of improving operability, and thus the protruding portion 27 is inserted into the first recessed portion 12w by aligning the positions of the markings 12δ and 21a in the circumferential direction. Note that the markings 12δ and 21a are not essential.

Thereafter, the protruding portion 27 is slid along the first recessed portion 12w to bring the protruding portion 27 into contact with the end portion 12z. This results in the state illustrated in FIGS. 19(B) and 20(B).

Since the first recessed portion 12w and the second recessed portion 12x are coupled at and near the end portion 12z, the filter element 10C and the fixing member 20C can be relatively rotated in the state illustrated in FIGS. 19(B) and 20(B). In the present embodiment, since the fixing member 20C is fixed to a tank or the like, the filter element 10C is rotated (counterclockwise in FIG. 19, and clockwise in FIG. 20).

When the filter element 10C, that is, the recessed portion 12v is rotated (see the arrow in FIG. 20(B)) from the state illustrated in FIG. 20(B), the protruding portion 27 moves along the second recessed portion 12x, and then the protruding portion 27b is inserted into the recessed portion 12γ located at an end of the second recessed portion 12x as illustrated in FIG. 20(C). As a result, the filter element 10C is mounted to the fixing member 20C. Since the depths of the second recessed portion 12x and the recessed portion 12γ are greater than the heights of the protruding portion 27a and the protruding portion 27b, respectively, no unnecessary force is applied to the tubular portion 22C.

In addition, since the sealing member 39 is provided at the groove 12u, the sealing member 39 is provided between the filter element 10C and the fixing member 20C in the state where the fixing member 20C is fixed to the filter element 10C. In the filtering device 4, the valve 30A is provided inside the tubular portion 12s and the tubular portion 22C, and therefore it is essential to prevent leakage of liquid when the valve 30A opens. The sealing member 39 can provide a seal such that liquid does not leak to the outside from between the filter element 10C and the fixing member 20C even when the valve 30A opens.

In this manner, once the filter element 10C and the fixing member 20C are assembled, the filtering device 4 becomes usable by mounting the filter case to the body portion (including the fixing member 20C). Since the filtration performance of the filtering member 11 gradually decreases as it filters the liquid, the filter element 10C is replaced periodically or as necessary.

First, the filter case is removed from the body portion to expose the filter element 10C. Thereafter, the filter element 10C is rotated clockwise as viewed from the front side (in a direction opposite to that during assembly), thereby moving the protruding portion 27 along the second recessed portion 12x and placing the protruding portion 27 inside the first recessed portion 12w. Thereafter, the filter element 10C is moved in a direction away from the fixing member 20C along the central axis ax, thereby removing the filter element 10C from the fixing member 20C. Thus, replacement of the filter element 10C is completed.

According to the present embodiment, the filter element 10C is mounted to the fixing member 20C by moving the protruding portion 27 along the second recessed portion 12x, that is, rotating the filter element 10C with respect to the fixing member 20C, and thus it is possible to prevent the filter element from falling off in an unintended situation.

Note that in the present embodiment, the protruding portion 27 is provided at the tubular portion 22C on the outside and the recessed portion 12v is provided at the tubular portion 12s on the inside, but a recessed portion may be provided at the tubular portion 22C on the outside and a protruding portion may be provided at the tubular portion 12i on the inside.

The embodiments of the present invention have been described above in detail with reference to the drawings, but specific configurations are not limited to the embodiments and changes in design or the like without departing from the gist of the invention are also included. A person skilled in the art can appropriately change, add, and convert each element in the embodiments.

In the present invention, “substantially” refers to a concept that includes not only cases of being strictly identical, but also includes errors and deformations that do not lose their identity. For example, the term “substantially same” is not limited to the case of being strictly same, but is a concept that includes an error to the extent not losing sameness. Further, for example, when simply expressed as “same,” it also includes a case of substantially same, in addition to the case of being strictly same. In the present invention, “vicinity” means a region that includes a range (which can be defined arbitrarily) near a reference position. For example, the case of expressing “in the vicinity of A” is a concept that a region in a certain range near A may include A or may not include A.

### REFERENCE SIGNS LIST

1, 2, 3, 4: Filtering device

10, 10A, 10B, 10C: Filter element

11: Filtering member

12, 12A, 12B, 12C: Plate

12a, 12j: Body portion

12b, 12f, 12l: Plate-shaped portion

12c, 12d, 12h, 12i, 12k, 12m, 12n, 12s: Tubular portion

12e: Fixing portion

12g, 12o, 12p, 12q: Protruding portion

12r, 12δ: Marking

12t: Outer peripheral surface

12u: Groove

12v: Recessed portion

12w: First recessed portion

12x: Second recessed portion

12y: Opening edge

12z: End portion

12α: Shallow groove portion

12β: Deep groove portion

12γ: Recessed portion

13, 13A: Plate

14: Outer tube

15: Inner tube

20, 20A, 20B, 20C, 20D: Fixing member

21, 21A, 21B: Plate-shaped portion

21a, 21b: Marking

22, 22A, 22B, 22C, 22D: Tubular portion

22a: Outer peripheral surface

22b, 22g: Opening edge

22c: Flat surface

22d, 22h: Chamfered portion

22i: Holding portion

22j: Coupling portion

22m: Inner peripheral surface

22k, 22l, 23: Hole

24: Groove

25: Holding portion

25a: Hole

26, 26A: Recessed portion

26a, 26d: First recessed portion

26b, 26e: Second recessed portion

26c, 26f: End portion

26g: Shallow groove portion

26h: Deep groove portion

26i: Recessed portion

27, 27a, 27b: Protruding portion

30, 30A, 30B: Valve

31: Rod-shaped member

32, 32A: Valve element

33, 33A, 33B: Holding portion

34: Elastic member

39: Sealing member

40: Cover portion

41: Coupling portion

42: Cover

42a: Tubular portion

50: Mounting portion

51: Plate-shaped portion

52: Shaft

53: Coupling portion

54: Elastic member

1. A filtering device comprising:
a fixing member;
a filter element including a filtering member having a cylindrical shape and a plate provided at one end of the filtering member;
a valve provided at the fixing member or the filter element; and
a sealing member having an annular shape and provided at the fixing member or the filter element, wherein
a first tubular portion including a protruding portion is provided at one of the fixing member and the plate, and a second tubular portion including a recessed portion into which the protruding portion is inserted is provided at the other of the fixing member and the plate,
the recessed portion has a shape in which a first recessed portion with one end opening at an opening edge of the second tubular portion, and a second recessed portion extending along a circumferential direction are coupled with each other,
the protruding portion is inserted into the recessed portion when one of the first tubular portion and the second tubular portion is inserted into the other of the first tubular portion and the second tubular portion, and
when the protruding portion is inserted into the first recessed portion from the opening edge, moved along the first recessed portion, and moved along the second recessed portion, the first tubular portion and the second tubular portion are mounted, the valve is inserted into the first tubular portion and the second tubular portion, and the sealing member is provided between the first tubular portion and the second tubular portion.

2. The filtering device according to claim 1, wherein
the plate includes the first tubular portion,
the fixing member includes the second tubular portion,
the second tubular portion is inserted into a hollow portion of the first tubular portion,
the valve is inserted into a hollow portion of the second tubular portion,
the plate is formed by bending a plate-shaped member, and includes a body portion and a fixing portion fixed to the body portion, the body portion including a portion having an annular shape, and
the protruding portion is a portion of the fixing portion.

3. The filtering device according to claim 2, wherein a wall thickness of the second tubular portion is greater than a wall thickness of the plate-shaped member.

4. The filtering device according to claim 1, wherein
the protruding portion includes a first protruding portion and a second protruding portion higher than the first protruding portion,
a third recessed portion deeper than the second recessed portion is provided at an end of the second recessed portion on a side not coupled with the first recessed portion,
a depth of the second recessed portion is equal to or greater than a height of the first protruding portion,
a depth of the third recessed portion is equal to or greater than a height of the second protruding portion, and
in a state where the first tubular portion and the second tubular portion are fixed, the first protruding portion is inserted inside the second recessed portion, and the second protruding portion is inserted inside the third recessed portion.

5. The filtering device according to claim 4, wherein
an inner diameter of a hollow portion of the first tubular portion is greater than a diameter of a hollow portion of the second tubular portion,
the second tubular portion is inserted into the hollow portion of the first tubular portion,
the depth of the second recessed portion is smaller than the height of the second protruding portion, and
a wall thickness of the first tubular portion is smaller than a wall thickness of the second tubular portion.

6. The filtering device according to claim 1, wherein
the second tubular portion includes a groove where the sealing member is provided, and
the groove is provided adjacent to the second recessed portion over an entire circumference in the circumferential direction.

7. A mounting structure configured to mount a fixing member and a filter element, the filter element including a filtering member having a cylindrical shape and a plate provided at one end of the filtering member, wherein
a first tubular portion including a protruding portion is provided at one of the fixing member and the plate, and a second tubular portion including a recessed portion into which the protruding portion is inserted is provided at the other of the fixing member and the plate,
the recessed portion has a shape in which a first recessed portion with one end opening at an opening edge of the second tubular portion, and a second recessed portion extending along a circumferential direction are coupled with each other,
the protruding portion is inserted into the recessed portion when one of the first tubular portion and the second tubular portion is inserted into the other of the first tubular portion and the second tubular portion, and
when the protruding portion is inserted into the first recessed portion from the opening edge, moved along the first recessed portion, and moved along the second recessed portion, the first tubular portion and the second tubular portion are mounted, a valve is inserted into the first tubular portion and the second tubular portion, and a sealing member having an annular shape is provided between the first tubular portion and the second tubular portion.

8. The filtering device according to claim 2, wherein
the second tubular portion includes a groove where the sealing member is provided, and
the groove is provided adjacent to the second recessed portion over an entire circumference in the circumferential direction.

9. The filtering device according to claim 3, wherein
the second tubular portion includes a groove where the sealing member is provided, and
the groove is provided adjacent to the second recessed portion over an entire circumference in the circumferential direction.

10. The filtering device according to claim 4, wherein
the second tubular portion includes a groove where the sealing member is provided, and
the groove is provided adjacent to the second recessed portion over an entire circumference in the circumferential direction.

11. The filtering device according to claim 5, wherein
the second tubular portion includes a groove where the sealing member is provided, and
the groove is provided adjacent to the second recessed portion over an entire circumference in the circumferential direction.
